(19) United States
(12) Patent Application Publication
(10) Pub. No.: US 2007/0288183 A1
(43) Pub. Date: Dec. 13, 2007

(54) ANALOG SIGNAL TRANSITION DETECTOR

(76) Inventors: Cherik Bulkes, Sussex, WI (US); Stephen Denker, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 11/759,489

(22) Filed: Jun. 7, 2007

Related U.S. Application Data
(60) Provisional application No. 60/811,535, filed on Jun. 7, 2006.
(60) Provisional application No. 60/811,536, filed on Jun. 7, 2006.

(51) Int. Cl. G06F 19/00

(52) U.S. Cl. 702/66; 702/1; 702/127; 702/189; 702/57

(57) ABSTRACT

An apparatus configured to detect transitions between relatively rising and falling amplitudes of an input signal Vin(t) arriving at a input node comprises a comparator having a first input, a second input, and an output for providing a two state output signal Vout(t) wherein state changes in the output signal Vout(t) correspond to the relatively rising amplitude of the input signal Vin(t) and the relatively falling amplitude of the input signal Vin(t). A delay circuit provides a shifted signal Vin(t+Δt) to the second input of the comparator, and a hysteresis circuit provides hysteretic deadband appended input signal Vin+ΔV to the first input of the comparator.

### CROSS-REFERENCE TO RELATED APPLICATIONS

This application claims benefit of U.S. Provisional Patent Application No. 60/811,535 filed on Jun. 7, 2006, and U.S. Provisional Patent Application No. 60/811,536 filed on Jun. 7, 2006.

### STATEMENT REGARDING FEDERALLY SPONSORED RESEARCH OR DEVELOPMENT

Not Applicable

### BACKGROUND OF THE INVENTION

1. Field of the Invention

The present invention relates apparatus for detecting predefined transitions in analog signals, and more particularly to such apparatus that accurately detects small features in composite analog signals.

2. Description of the Related Art

A comparator is commonly used to compare two voltages and switches its output to indicate which voltage is greater. A standard operational amplifier without negative feedback can be used as a comparator. When the voltage is applied the non-inverting input (V+) of the operational amplifier is greater than the voltage at the inverting input (V−), the high gain of the operational amplifier causes its output to be at as positive a voltage as possible based on the voltage supplied to the amplifier. When the voltage at the non-inverting input is less than voltage at the inverting input (V−), the operational amplifier outputs the lowest possible voltage. Since the output voltage is limited by the supply voltage, for an operational amplifier that uses a balanced, split supply, (powered by ±V_{S}) this action can be defined as: Vₒᵤₜ=V_{S}sgn(V₊−V₋), where sgn(x) is the signum function, which is equal to −1 for negative values of x, +1 for positive values of x, and 0 when the value of x is zero. Generally, the positive and negative voltage supplies V_{S} will not match absolute value: Vₒᵤₜ≦V_{S+} when (V₊>V₋) else V_{S-} when (V₊<V₋). Equality of input values is very difficult to achieve in practice. The speed at which the change in output results from a change in input is typically in the order of 10 ns to 100 ns, but can be as slow as a few tens of microseconds.

A dedicated voltage comparator integrated circuit, such as a model LM339, is designed to interface directly to digital logic. The output is a binary state, and it is often used to interface real world signals to digital circuitry. A dedicated voltage comparator is generally faster than a general-purpose operational amplifier pressed into service as a comparator. A dedicated voltage comparator may also contain additional features such as an accurate, internal voltage reference and adjustable hysteresis. When comparing a noisy signal to a threshold, the comparator may switch rapidly from state to state as the signal crosses the threshold. If this is unwanted, a Schmitt trigger can be used to provide hysteresis and a cleaner output signal.

In spite of being common electronic devices, comparators have never been used as signal feature detectors. There are several reasons for this. Usually comparators require a reference input that traditionally was chosen as zero voltage or another fixed reference voltage. With low frequency contamination the “baseline” or “the zero line” may wander and compromise accurate zero crossing detection. In this case, the signal may be prevented from crossing the baseline as a result of low frequency content. To address this, one solution has been to amplify the signal into a fixed amplitude limit, thereby removing the amplitude information before applying the zero crossing detection. The result is a “band limited signal” that does not contain any valid signal components above or below cutoff frequencies of a pass band. Nevertheless, a band limited signal contains low amplitude components from the stop bands, i.e. frequencies above or below the pass band, or noise. The low frequency content would still be prevalent and cause inaccuracies in signal detection. Such noise may cause erroneous detection of “zero crossings.”

Many signal processing applications require robust detection of signal transitions, for example, in systems for signature or spectral analysis. Such applications arise in signals sensed from implanted medical devices, signals analyzed for vibration analyzers, and speech signal processors to name only a few. The problems encountered in these areas are described in detail next.

### Reliable Signal Transition Detection in Physiological Data:

Despite major advances in the diagnosis and treatment of heart disease over the past decades, a substantial number (350,000 in the USA) of patients each year suffer sudden cardiac arrest (SCA) due to, for example, ventricular tachycardia (VT) or ventricular fibrillation (VF). However, the national survival rate of sudden cardiac arrest is merely about 5%. The standard therapy for sudden cardiac arrest is early cardioversion/defibrillation, either by implantable cardioverter defibrillators (ICD) or by automatic external defibrillator (AED). An important parameter that affects the reliability and accuracy of these therapies is the algorithm or technique used to detect shockable ventricular tachycardia and ventricular fibrillation and while avoiding unnecessary shocks possibly caused by non-shockable tachyarrhythmias (e.g. supraventricular tachycardia (SVT), atrial fibrillation (AF), etc.) and some high frequency noise commonly encountered under practical situations. Electrical shocks are uncomfortable and disconcerting to the patient in addition to causing some minor damage.

Since electrical shocks always have adverse affects on the myocardium, another primary goal of all cardiac therapies is to minimize the number and energy level of electrical signals delivered to the patient. To this end, ventricular tachycardia, which requires much lower energy levels for effective therapy, must be effectively differentiated from ventricular fibrillation. Moreover, the safety of a device, as well as its ease of use, extent of automatic operation, and widespread acceptance also depends on the performance of the arrhythmia detection system and method. All devices and systems monitoring the cardiac state of a patient and/or generating anti-tachyarrhythmia therapy rely on analysis of the electrocardiogram (ECG) from the patient. The analyses proposed and used so far were based on manipulation of information in the time-domain, frequency-domain, time-frequency domain, bi-spectral domain, and even nonlinear dynamics domain. However, all these manipulations have fundamental limitations associated with the linear nature, computational complexity, or difficulty in real-time implementation as well as low sensitivity and specificity. For this reason, currently, the percentage of patients with ICDs who are paced or shocked unnecessarily exceeds 40%. Similarly, AEDs are only approximately 90% effective or sufficiently specific in detecting ventricular tachyarrhythmia and about 90-95% accurate in detecting and correctly classifying other heart rhythms. Moreover, discrimination of ventricular tachycardia from ventricular fibrillation is still a difficult object to achieve using conventional algorithms for ICD and AED. Therefore, a need still exists for a simple and effective arrhythmia detection system and method.

It should be appreciated that the defibrillation detection circuit can take many forms, and can hence be interrogated in several ways. Here, for purposes of illustration, it is assumed that the fibrillation detector circuit is a simple type, such as described in U.S. Pat. No. 4,202,340 for example. The detector circuit includes automatic gain control capabilities and detects fibrillation by evaluating the period of time that a filtered ECG signal spends outside a predetermined window. Accordingly, the fault detect circuits include an out of window detector and a high gain detector. After the first level comparator actuates the two fault-detection circuits, the interrogation of the fibrillation detector circuit begins. First, the out of window detector looks to see whether the filtered ECG signal is out of the detector's window for more than a predetermined length of time. If the filtered ECG signal stays out of the window for more than one to two seconds, a malfunction is indicated.

More sophisticated methods model the electrical activity of the heart by a non-linear dynamical system. Such systems are described by non-linear dynamics theory, which can be used therefore to analyze the dynamic mechanisms underlying the cardiac activities. Dynamical systems such as the heart can exhibit both periodic and chaotic behaviors depending on certain system parameters. For instance, ventricular fibrillation is a highly complex, seemingly random phenomenon, and can be described as chaotic cardiac behavior. Therefore, a diagnostic system with the ability to quantify abnormalities of a non-linear dynamic cardiac system would be expected to have an enhanced performance. In fact, methods have been described which were derived from nonlinear dynamics in ECG signal processing and arrhythmia prediction and detection. For example, Poincare map or return map of the ECG amplitude for cardiac fibrillation detection was disclosed in U.S. Pat. No. 5,439,004. U.S. Pat. No. 5,643,325 disclosed the degree of deterministic chaos in phase-plane plot may indicate a propensity for fibrillation including both the risk of fibrillation and the actual onset of fibrillation. A method for detecting a heart disorder using correlation dimension (by Grassberger-Procaccia algorithm) was also disclosed in U.S. Pat. No. 5,643,325. A slope filtered point-wise correlation dimension algorithm is utilized to predict imminent fibrillation, as disclosed in U.S. Pat. No. 5,425,749. These and other non-linear dynamics derived methods are based on the phase space reconstruction, and the computational demand and complexity are considerable for current ICD and AED, therefore, they are still difficult to apply in the real world.

The cardiac electrical signal is the complex result of a plurality of spatial and temporal inputs and many non-linear dynamic features or characteristics should be expected in this signal, such as different spatio-temporal patterns manifested in the ECG. One such dynamic feature is referred to as “complexity.” Different non-linear dynamic cardiac behavior is associated with different degrees of complexity. Therefore, the measure characterizing complexity can be used as an effective tool for detecting ventricular tachycardia and ventricular fibrillation. Correlation dimension and approximate entropy have been proposed as means of characterizing complexity, however, these approaches require highly accurate calculations involving long data segments and are very time-consuming. Hence, these approaches cannot be extended to real-time application in ICD and AED. However, none of these references mention the way to perform real-time complexity analysis in ICDs and AEDs. Moreover, none of these references discusses a method that can be used to avoid unnecessary therapy caused by SVT or high-frequency noise.

A system and method for complexity analysis-based tachycardia detection is described in U.S. Pat. No. 6,490,478. This technique while being computationally efficient still depends on the filtered signal provided to the algorithm.

In view of the clinical importance of ventricular conditions, more emphasis should be put on the analysis and feature extraction of the ventricular electrical activity, manifested as QRS complex of the ECG.

Therefore, there is a need for a simple, computationally efficient method that is effective, robust, reliable, and well suited for real-time implementation. Such a method should have immunity to noise and artifacts. Therefore, it offers all the desirable features for the practical application in AED, ICD and other applications.

### Signal Detection in Speech Processing Application:

Automatic speech recognition is useful as a multimedia browsing tool that allows easy searching and indexing recorded audio and video data. Speech recognition is also useful as a form of input. It is especially useful when someone's hands or eyes are busy. It allows people working in active environments, such as hospitals, to use computers. It also allows computer use by people with handicaps, such as blindness or palsy. Finally, although everyone knows how to talk, not as many people know how to type. With speech recognition, typing would no longer be a necessary skill for using a computer. If we ever were successful enough to be able to combine it with natural language understanding, it would make computers accessible to people who do not want to learn the technical details of using them.

Many improvements have been realized in the last 50 years, but computers are still not able to understand every single word pronounced by everyone.

Speech recognition is still fraught with many difficulties. The main one is that two speakers may say the same word very differently, known as inter-speaker variation (variation between speakers). Another difficulty is that the same person does not pronounce the same word identically on all occasions, which is known as intra-speaker variation. Even consecutive utterances of the same word by the same speaker can be different. Again, a human would not be confused by this, but a computer might. The waveform of a speech signal also depends on the background conditions (noise, reverberation, etc.). Noise and channel distortions are very difficult to handle, especially when there is no a priori knowledge of the noise or the distortion.

A speech recognition process can be divided into different component blocks. The first block consists of the acoustic environment plus the transduction equipment (microphone, preamplifier, filtering, A/D converter). This block can have a strong effect on the generated speech representations. For instance, additive noise, room reverberation, microphone position and type of microphone all can be associated with this part of the process. The second block, the feature extraction subsystem, is intended to deal with these problems, as well as deriving acoustic representations that are both good at separating classes of speech sounds and effective at suppressing irrelevant sources of variation.

The next two blocks illustrate the core acoustic pattern matching operations of speech recognition. Nearly all automatic speech recognition systems compute a representation of speech, such as a spectral or cepstral representation, over successive intervals, e.g., 100 times per second. These representations, or speech frames, are then compared to the spectra or cepstra of frames that were used for training, using some measure of similarity or distance. Each of these comparisons can be viewed as a local match. The global match is a search for the best sequence of words (in the sense of the best match to the data), and is determined by integrating many local matches. The local match does not typically produce a single hard choice of the closest speech class, but rather a group of distances or probabilities corresponding to possible sounds. These are then used as part of a global search or decoding to find an approximation to the closest (or most probable) sequence of speech classes, or ideally to the most likely sequence of words. Another key function of this global decoding block is to compensate for temporal distortions that occur in normal speech. For instance, vowels are typically shortened in rapid speech, while some consonants may remain nearly the same length.

The recognition process is based on statistical models (Hidden Markov Models) that are now widely used in speech recognition. A hidden Markov model (HMM) is typically defined (and represented) as a stochastic finite state automaton (SFSA), which is assumed to be built up from a finite set of possible states, each of those states being associated with a specific probability distribution (or probability density function, in the case of likelihoods). Ideally, there should be a HMM for every possible utterance, however, that is clearly infeasible. A sentence is thus modeled as a sequence of words. Some recognizers operate at the word level, but if we are dealing with any substantial vocabulary (say over 100 words or so) it is usually necessary to further reduce the number of parameters (and, consequently, the required amount of training material). To avoid the need of a new training phase each time a new word is added to the lexicon, word models are often composed of concatenated sub-word units. Any word can be split into acoustic units. Although there are good linguistic arguments for choosing units such as syllables or demi-syllables, the units most commonly used are speech sounds (phones) that are acoustic realizations of linguistic units called phonemes. Phonemes are speech sound categories that are meant to differentiate between different words in a language. One or more HMM states are commonly used to model a segment of speech corresponding to a phone. Word models consist of concatenations of phone or phoneme models (constrained by pronunciations from a lexicon), and sentence models consist of concatenations of word models (constrained by a grammar).

In the above description of the speech recognition framework, it should be noted that signal acquisition and feature extraction forms the fundamental basis for the entire speech recognition process. If these steps are compromised, the promise of automatic speech recognition will not reach the expected potential. For example, in the prior art techniques, the signal acquisition requires the step of anti-aliasing filtering to ensure that analog to digital (A/D) conversion step will not produce undesirable signals and complicate feature extraction. However, an anti-aliasing filter can eliminate signal features that would never reach the signal extraction step. Therefore, there is need to rethink the shortcomings of the current signal acquisition systems so that robust signal feature extraction is possible.

For speech processing, a common method is to band pass filter and compress the signal to minimize dynamic range, and then pass this through a signal transition detector. Signal amplitude compression tends to produce a constant amplitude signal, or at least with minimal dynamic range.

The desired detector, however, should not be amplitude dependant, and thus not directly be affected by band pass filtering controlling amplitude. The desired detector can be based on transition detection. Since for every zero crossing there will be a peak transition, either from negative to positive or vice versa, counting peak transitions is similar to zero crossings. Unlike zero crossings, however, signal transitions everywhere could be detected without need for a specific threshold that may change with average signal. Moreover, detection of peak transitions may allow computation of time difference between signal transitions, which essentially carry the frequency information. The desired detector can have an implied response limit, but it can be chosen to allow processing of a full bandwidth, such as 200 Hz-4000 Hz for speech, or 10 Hz-300 Hz for biological signal analysis. Higher or lower values can be achieved by component selection. Therefore, there is a need for an invention that does not lose signals with the usual filtering processes and lends itself more amenable to robust feature detection.

### SUMMARY OF THE INVENTION

In accordance with one aspect of the current invention, an apparatus is configured to detect transitions between relatively rising and falling amplitudes of an input signal Vin(t) contaminated with a noise signal n(t) arriving at a circuit input. That apparatus comprises a comparator circuit having first and second inputs and an output for providing a two-state output signal which changes states in response to the relatively rising amplitude of the input signal Vin(t) and the relatively falling amplitude of the input signal Vin(t). A delay circuit is configured to shift input signal by a predefined amount of time and applied that shifted signal to the second input of the comparator. A hysteresis circuit provides hysteretic deadband that is appended the input signal at the first input of the comparator, wherein the hysteretic deadband is proportional to a resistor ratio of a first resistor connected between the circuit input and the first input to the comparator, and a second resistor connected between the first input to the comparator and the output of the comparator. The resistor ratio is selected to be proportional to amplitude of the noise signal n(t). The shifted signal may be time shifted which is a wideband signal over two octaves or phase shifted which is narrow band less than one octave.

A further aspect of the invention involves having the input signal Vin(t) as a band limited signal which can be one of an electrical, mechanical, acoustic or an ultrasound signal. An exemplary electrical signal is an electrocardiogram in the frequency range of 10 Hz to 300 Hz. An exemplary mechanical signal is a vibration signal. An example for acoustic signal is a human voice signal in the frequency range of 20 Hz to 4000 Hz.

In accordance with another aspect of the invention, a computer implemented method detects transitions between relatively rising and falling amplitudes of an input signal Vin(t) contaminated with a noise signal n(t). That method provides a comparator function having a first and a second input and an output at which a two-state output signal Vout(t) is produced. The changes in states of the output signal correspond to the relatively rising amplitude of the input signal Vin(t) and the relatively falling amplitude of the input signal Vin(t). The method further involves applying a delay function to shifted signal Vin(t+Δt) to the second input of the comparator function; and applying a hysteresis function to append a hysteretic deadband to input signal Vin+ΔV to the first input of the comparator function wherein the hysteretic deadband ΔV is proportional to the amplitude of the noise signal n(t).

### BRIEF DESCRIPTION OF DRAWINGS

FIG. 1A is a schematic diagram of a transition detection circuit according to the present invention;

FIG. 1B depicts waveforms of electrical signals at various locations in the transition detection circuit;

FIG. 2 is set of waveforms depicting a signal processing deadband;

FIG. 3 shows a schematic diagram of a fixed element signal transition detector;

FIG. 4 is a schematic diagram of an adaptive signal transition detector;

FIG. 5 schematically illustrates the signal path through a single, fixed signal transition detector;

FIG. 6 schematically illustrates the signal path through a single, adaptive signal transition detector;

FIG. 7 is a schematic diagram of the signal path through a multiple, fixed signal transition detector; and

FIG. 8 shows the signal path through a multiple, adaptive signal transition detector.

### DETAILED DESCRIPTION OF THE INVENTION

Although the present invention is described in the context of transition detection of physiological signals, the present signal feature detector may be used for a variety of signals, including but not limited to electrical, mechanical, acoustic and ultrasound signals. It is important that the input signal Vin(t) to the detector is a band limited signal.

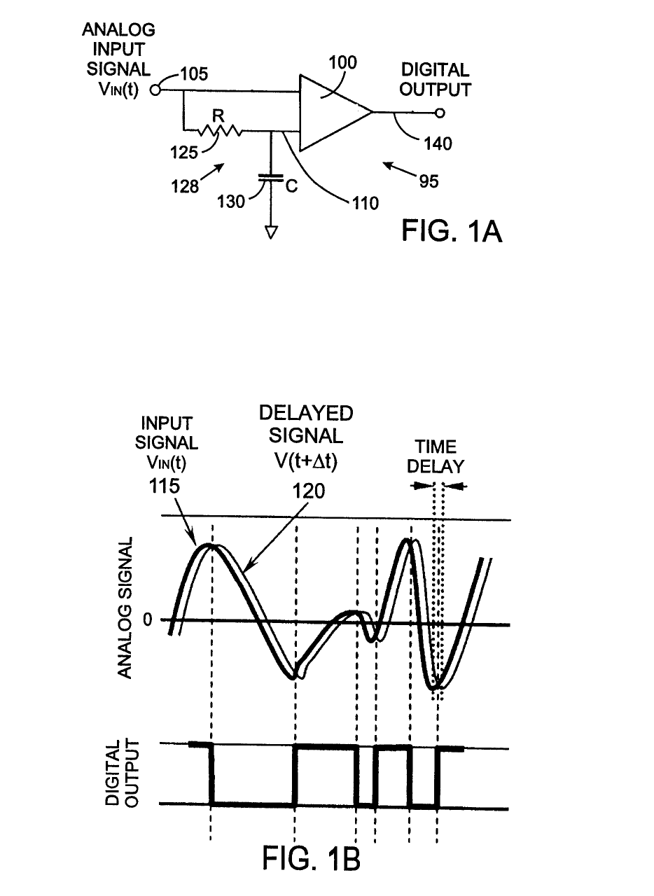

Initially, referring to FIGS. 1A and 1B, a hardware implementation of a signal feature detector 95 according to the present invention includes a comparator 100, which receives the input signal Vin(t) at and input node 105 to be containing transitions to be detected and receives a time-shifted version of that signal Vin(t+Δt) 110. An exemplary input signal Vin(t) is depicted by line 115 and with waveform 120 corresponding to the time-shifted signal Vin(t+Δt). In response to those signals, the comparator 100 identifies features in the input signal Vin(t) that are distinguished by having a local zero derivative representing the change of direction of the signal amplitude. The signal feature detector can be implemented using a conventional operational amplifier for input signals at frequencies less than 200 Hz. For higher frequency input signals, a comparator type operational amplifier is preferred to provide a digital output signal with well-defined slopes.

The method is sensitive to the time delay value, which separates the input signals in time. The time delay value is controlled by a signal shifter 128 the resistor (R) 125 and capacitor (C) 130. In a preferred embodiment, the RC time constant is set to exclude certain portions of the input signal time sequence. This decision is application dependent. Although the input voltage of the signal feature detector 95 is analog, that voltage at its output 140 is digital, or binary, with the high and low states.

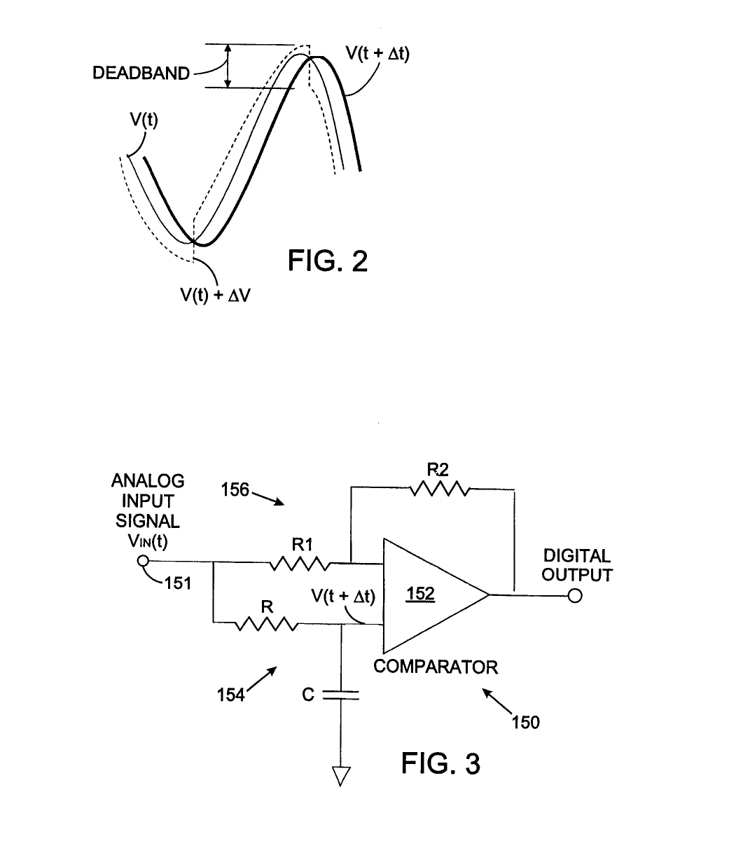

With reference to FIG. 2, the waveforms and the amplitude transition threshold (deadband) needed to trip the comparator 100 are functions of the associated hysteresis of the circuit, and the open loop gain of the comparator. The hysteresis amount ΔV can be chosen based on the component selection.

FIG. 3 shows a single, fixed element signal transition detector (STD) 150 which is similar to the circuit 95 shown in FIG. 1 with additional resistive elements providing feedback. This STD 150 has an input node 151 for receiving the input signal Vin(t). The resistors R1 and R2 are chosen such that the ratio of their resistances is proportional to the desired hysteresis and thus form a hysteresis circuit 156. The components R and C constitute a signal shifter 154 in the form of a delay circuit and the values of these components determine the time constant of the signal delay. The threshold at which the comparator 152 switches states is a function of the gain and slew rate of the comparator or operational amplifier at the frequencies of interest. Typically the gain roll off rate is 20 dB/decade from 1 kHz onward. With such a roll off point, a 105 dB gain at 1 kHz reduces to a gain of 65 dB at 100 kHz. The slew rate is the maximum rate by which the output can change state. For example, a 1 volt/msec slew rate would require at least 5 ms to go from 0 to 5 volts, regardless how hard the input is being overdriven.

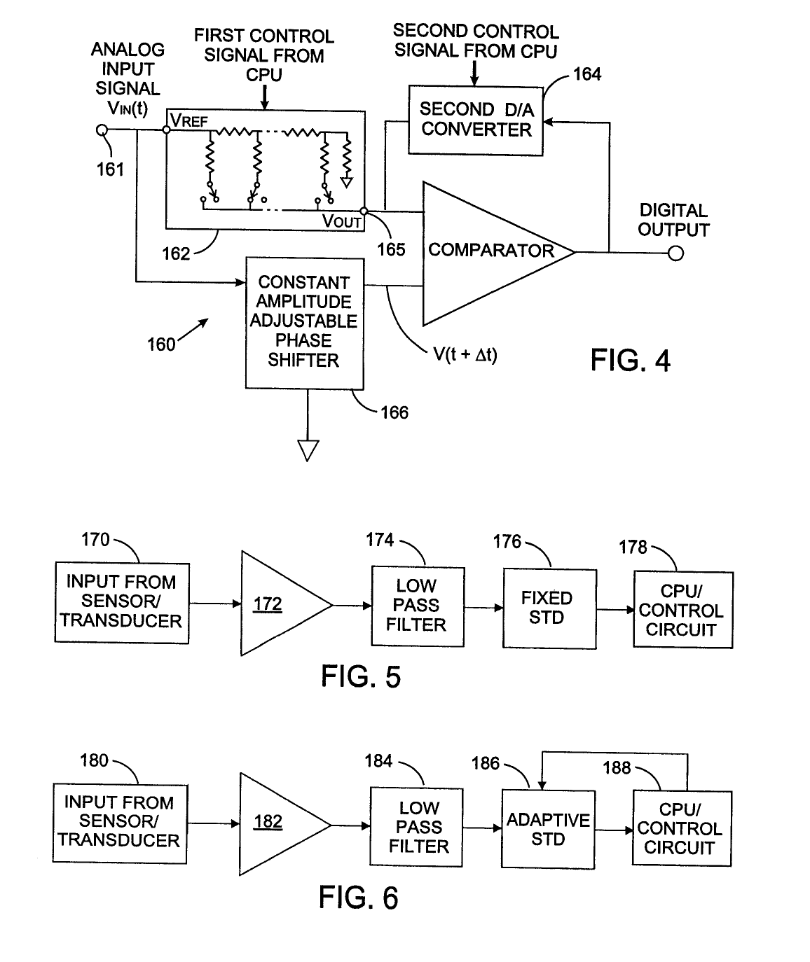

FIG. 4 shows an adaptive signal transition detector 160 which may be desired for applications requiring adjustable delay and deadband. This adaptive STD 160 has an input node 161 for receiving the input signal Vin(t). Here, the resistors R1 and R2 in FIG. 3 have been replaced by digital-to-analog (D/A) converters 162 and 164, such as a model DAC0830 manufactured by National Semiconductor of Santa Clara, Calif., USA., the details of which ware schematically illustrated for the first one 162 being shown. The D/A converters 162 and 164 receive multiple bit, digital control signals from a control circuit of the signal processing device (for example, a central processing unit, CPU), wherein each bit controls the state of one of the switches in the respective D/A converter. The states of the switches alter the voltage at the output 165 of the converter, which causes the D/A converter to behave as a programmable resistor. Similarly, to further improve adaptability of the delay circuit, the RC circuit of FIG. 3 has been replaced with a well known constant-amplitude variable phase shifter 166. Any of several well-known constant amplitude, variable phase shifters may be used, such as the one described in U.S. Pat. No. 4,663,594, for example.

FIG. 5 shows the overall signal path while passing through a single branch, fixed element signal transition detector (STD) that was previously described with respect to FIG. 3. The electrical signal being processed is produced by either a sensor or a transducer 170. After passing through amplifier 172, the signal is fed into a low pass filter (LPF) 174 having a corner frequency that is greater than the operating frequency range of an application in which the signal transition detector (STD) is used. However, the corner frequency of the low pass filter 174 is lower than the corner frequency of the delay circuit in STD 176. As an example, for an application with a frequency range of 10-300 Hz, the corner frequency of low pass filter may be at 1 kHz, while that of the delay circuit may at 10 kHz. In another example, for an application with a frequency range of 300-3000 Hz, the corner frequency of low pass filter may be at 10 kHz, while that of the delay circuit may at 100 kHz. In any case, the frequency of the low pass filter and the STD delay circuit is chosen such that there is negligible signal degradation due to the low pass filtering operation at the specified frequency range of 10-300 Hz. Without low pass filtering the overall signal arriving at STD 176, the delay circuit of STD would behave like a low pass filter at the input of comparator 152 and deteriorate the comparator performance. The STD 176 in this case is a single, fixed circuit and is similar to that shown in FIG. 3. The output of the STD circuit is digital as mentioned before and goes to the control circuit 178 which in one exemplary embodiment may be a central processing unit with memory and firmware for analyzing the signal.

FIG. 6 shows the overall signal path while passing through a single branch, adaptive element STD, such as the one shown in FIG. 4. The electrical signal being processed is produced by either a sensor or a transducer 180. The signal is then passed through amplifier 182 and a low pass filter 184 that has similar operating characteristics as described with respect to the filter 175 in FIG. 5. However, the corner frequency of the low pass filter is less than the corner frequency of the delay circuit in the STD 186. The STD 186 in this case is a single, adaptive element circuit and is similar to the one shown in FIG. 4. The digital output of the STD 186 is applied to the control circuit 188 which analyzes the detected transitions and controls operation of the digital-to-analog converters 162 and 164 in the STD.

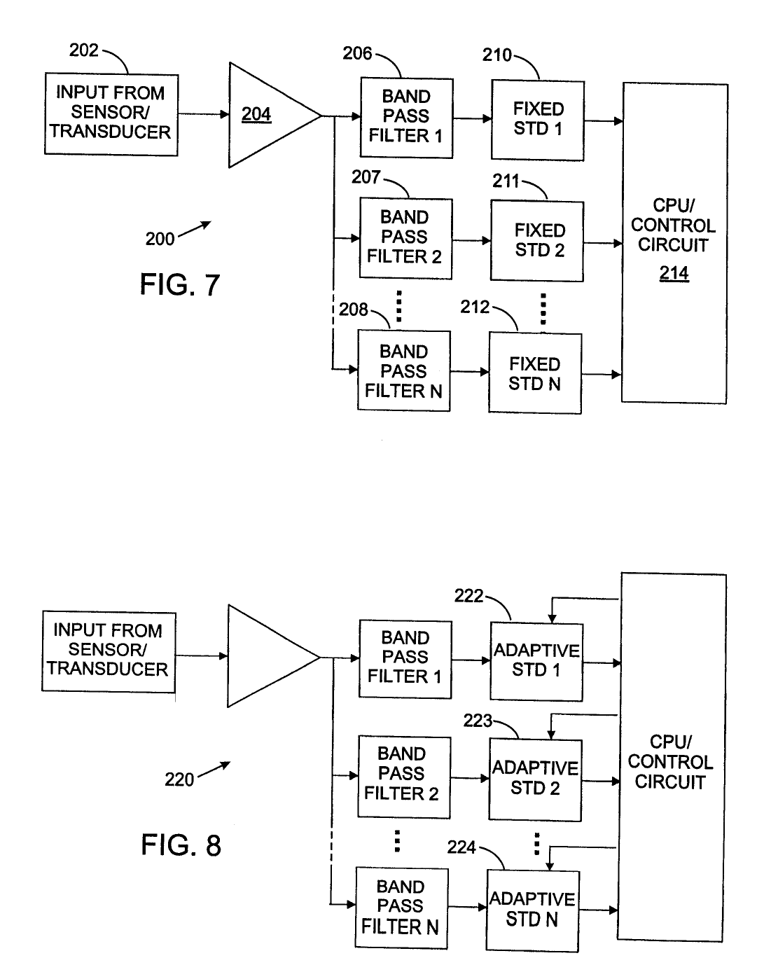

FIG. 7 shows the overall signal path of a multiple transition detector 200 which has multiple branches each configured to detect a different type of transition in an input signal. The signal from the sensor/transducer 202 is amplified by amplifier 203 which produces the input signal for transition detection. There are “N” circuit branches to detect N different types of signal transitions. Each branch comprises a band pass filter 206, 207 or 208 followed a fixed element STD 210, 211 or 212, respectively. The frequency ranges of band pass filters 206-208 are predetermined and work in tandem with the corner frequencies of the delay circuit in the associated STD 210-212. In one example, for an application in the frequency range of 10-300 Hz, the three circuit have the following configuration: band pass filter 206 has range of 5-80 Hz and the delay circuit in STD 210 operates in a range of 100-1600 Hz; band pass filter 204 has a range of 80-640 Hz and the delay circuit in STD 211 operating in the 1600-12800 Hz range; and band pass filter 208 has a range of 640-10240 Hz and the delay circuit in STD 212 operates the 12800-102400 Hz range. The outputs produced by the STDs 210, 211 or 212 are coupled to inputs to the CPU/control circuit 214. This multi-branch multiple transition detector 200 provides greater design flexibility when compared to a single branch configuration, but adds additional circuit elements.

FIG. 8 represents the overall signal path of a multiple transition detector 220 that employs adaptive element STDs 222, 223 and 224, but otherwise in the same as the multiple transition detector 200 in FIG. 7. Here the frequency ranges of band pass filters are programmable and work in tandem with the corner frequencies of the lag circuits of corresponding STDs, as described previously.

The present signal feature detector preferably is configured to detect transitions from relatively rising and relatively falling amplitudes of an input signal Vin(t) arriving at an input port. The signal feature detector comprises a comparator circuit that has first and second inputs and an output at which a two state output signal Vout(t) is produced, wherein state changes in the output signal Vout(t) correspond to the relatively rising amplitude of the input signal Vin(t) and the relatively falling amplitude of the input signal Vin(t). A delay circuit shifts the input signal by an amount of time Δt to provide a time shifted signal Vin(t+Δt) at the second input of the comparator. A hysteresis circuit produces hysteretic deadband signal Vin+ΔV which is appended to the first input of the comparator, wherein the hysteretic deadband ΔV is proportional to a ratio of a first resistor connected between the input port and the first comparator input and a second resistor connected between the comparator's first input and output. The resistor ratio is selected to be proportional to an amplitude of an anticipated noise signal n(t). The shifted signal may be time shifted which is a wideband signal over 2 octaves, or phase shifted which is narrow band less than 1 octave.

The input signal may be an electrocardiogram in the frequency range of 10 Hz to 300 Hz, a mechanical signal such as a vibration signal, or an acoustic signal, such as a human voice, in the frequency range of 20 Hz to 4000 Hz.

The output of the signal feature detector is a transformed signal which is discrete. It should be noted that this technique is immune to the variations in the continuous input signal unlike traditional methods. The discrete signal can be advantageously used for signal classification.

It should be understood that the signal feature detector can be implemented in hardware, as described previously or by software as will be described hereinafter. It may also be a combination of software and hardware.

Another embodiment of the signal feature detector is implemented by software that is executed by a computer. Here transitions between relatively rising and falling amplitudes of an input signal Vin(t) are detected by a comparator function that has a first and a second input and an output at which a two state output signal Vout(t) is produced, wherein state changes in the output signal correspond to the relatively rising and falling amplitude of the input signal. A delay function shifts the input signal by an amount of time Δt to apply a time shifted signal Vin(t+Δt) to the second input of the comparator function. A hysteresis function appends a hysteretic deadband signal Vin+ΔV to the first input of the comparator function wherein the hysteretic deadband ΔV is proportional to the amplitude of the anticipated noise signal n(t). In a computer implemented method, the delay functions, hysteresis functions and comparator functions of each signal feature detector are implemented in software or firmware.

### Application to Physiological Signal Detection:

In one example, a signal feature detector in conjunction with software executed by the control circuit can determine the heart rate which is used in an algorithm for pacing a patient's heart. The heart rate detection is based on the number of cardiac signal transitions counted over a predefined time interval. If the heart rate goes out of a defined range for a given length of time and the frequency of the transitions remain in the non-fibrillation range, cardiac pacing can be initiated to pace the patient's heart. When the transition frequency indicates atrial fibrillation stimulation for atrial defibrillation can be initiated.

In another example, the signal feature detector detects cardiac fibrillation and further comprises a pulse counter that counts the number of pulses for a preset time period. If the cardiac signal corresponds to the normal heart beat, the pulse counter would register a count in a predetermined normal range since the normal biological signals have transition changes at a relatively low rate. In the event of a fibrillation, the pulse count becomes dramatically different, much greater than normal, and analysis that count indicates the defibrillation event. The physiological noise also produces relatively large counts, but these counts do not add up to a sustained large number and thus can be differentiated from a fibrillation event. Unlike the traditional techniques, this method is robust being relatively immune to signal filter degradations and provides a greatly improved event detection and classification.

As another example, the heart rate determined by the signal feature detector is used in an algorithm for pacing a patient's heart. The heart rate detection is based on the number of transitions counted over a prespecified time interval. If the heart rate goes out of a given range for a predefined time and the frequency of the transitions remain in the non-fibrillation range, cardiac pacing can be initiated to pace the patient's heart.

In another application, when a discrete transition signal has been detected, it can be advantageously used to determine slope and slope duration analysis or any other methods of characterizing the QRS complex of an electrocardiogram (ECG) signal.

Moreover, instead of the ECG signal, the present inventive concept may be used with other physiological signals. These may include blood pressure, vasomotor tone, electromyography (EMG), electrodermography, electroneuography, electro-oculography (EOG), electroretinography (ERG), electronystagmography (ENG), video-oculography (VOG), infrared oculography (IROG), auditory evoked potentials (AEP), visual-evoked potentials (VEP), all kinds of Doppler signals, etc.

### Application to Speech Signal Detection:

For speech signal detection, the signal transition detector further comprises a training set of pulses corresponding to a person's speech segments using a known piece of text. Preferably the known piece of text includes the pronunciation signals corresponding to speech segments commonly encountered in practice. The pulse segments from a person's speech are matched to known segments and corresponding features are extracted and used in the speech recognition. If the present signal corresponds to the normal mode of speech, the speech feature detector would not be modified. In the event of variations in the speech, the segments can be dynamically modified by stretching or compressing of the speech segments such that most likely segment would find the match. The environmental noise signal will also have relatively large counts, but these counts would not add up to a sustained large number and thus can be differentiated from a normal speech. Unlike the traditional techniques, this method is robust and immune to signal filter degradations and provides a greatly improved event detection and classification.

As another example, the signal transition detector can be used to determine the speech tempo, which is used in an algorithm for modifying a response. The speech tempo detection is based on the number of transitions counted over a predefined time interval. If the speech tempo goes out of range for a predetermined time and the frequency of the transitions remain in the normal speech range, an operation such as automated stoppage of speech recognition can be initiated and the user can be alerted to change tempo of the recording.

Moreover, instead of the speech other audio signals may be processed by this inventive concept. These may include acoustic waveforms from various musical instruments, natural sounds etc.

The foregoing description was primarily directed to preferred embodiments of the invention. Even though some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. An apparatus configured to detect transitions of relatively rising and relatively falling amplitudes of an input signal Vin(t), said apparatus comprising:
an input node for receiving the input signal Vin(t);
a comparator having a first input, a second input, and an output for providing a two state output signal Vout(t), wherein state changes in the output signal Vout(t) correspond to the relatively rising amplitude of the input signal Vin(t) and the relatively falling amplitude of the input signal Vin(t);
a signal shifter configured to provide a shifted signal Vin(t+Δt) to the second input of the comparator; and
a hysteresis circuit configured to provide hysteretic deadband appended input signal Vin+ΔV to the first input of the comparator, wherein the hysteretic deadband ΔV is proportional to a ratio of a first value of a first resistor connected between the input node and the first input to the comparator and a second value of a second resistor connected between the first input to the comparator and the output of the comparator.

2. The apparatus cited in claim 1 wherein the input signal Vin(t) is frequency band limited.

3. The apparatus cited in claim 2 wherein the input signal is taken from a group containing: an electrical signal, a mechanical signal, an acoustic signal, and an ultrasonic signal.

4. The apparatus cited in claim 3 wherein the electrical signal is an electrocardiogram signal with a frequency range of 10 Hz to 300 Hz.

5. The apparatus cited in claim 3 wherein the mechanical signal is a vibration signal.

6. The apparatus cited in claim 3 wherein the acoustic signal is a human voice signal with a frequency range of 20 Hz to 4000 Hz.

7. The apparatus cited in claim 1 wherein the ratio is proportional to an amplitude of an anticipated noise signal.

8. The apparatus cited in claim 1 wherein the shifted signal provided by the signal shifter is one of a time shifted signal and a phase shifted signal.

9. The apparatus cited in claim 8 wherein the time shifted signal is a wideband composite signal covering more than 2 octaves.

10. The apparatus cited in claim 8 wherein the phase shifted signal is a narrow band signal covering less than 1 octave.

11. A computer implemented method to detect transitions between relatively rising and falling amplitudes of an input signal Vin(t), the computer implemented method comprising:
providing a comparator function having a first input, a second input, and an output for providing a two state output signal Vout(t) wherein state changes in the output signal Vout(t) correspond to the relatively rising amplitude of the input signal Vin(t) and the relatively falling amplitude of the input signal Vin(t);
providing a delay function to apply a shifted signal Vin(t+Δt) to the second input of the comparator function; and
providing a hysteresis function to append a hysteretic deadband to input signal Vin+ΔV to the first input of the comparator function, wherein the hysteretic deadband ΔV is programmably selected to be proportional to an amplitude of an anticipated noise signal.

12. The computer implemented method cited in claim 11 wherein the input signal Vin(t) is frequency band limited.

13. The computer implemented method cited in claim 12 wherein the input signal is from a group containing: an electrical signal, a mechanical signal, an acoustic signal, and an ultrasonic signal.

14. The computer implemented method cited in claim 13 wherein the input signal is an electrocardiogram signal with a frequency range of 10 Hz to 300 Hz.

15. The computer implemented method cited in claim 13 wherein the input signal is a vibration signal.

16. The computer implemented method cited in claim 13 wherein the input signal is a human voice signal with a frequency range of 20 Hz to 4000 Hz.

17. The computer implemented method cited in claim 11 wherein the shifted signal provided by the delay function is one of a time shift and a phase shift.

18. The computer implemented method cited in claim 17 wherein the shifted signal is a wideband composite signal covering more than 4 octaves.

19. The computer implemented method cited in claim 17 wherein the shifted signal is a narrowband signal covering fewer than 2 octaves.

20. An apparatus configured to detect transitions of relatively rising and relatively falling amplitudes of an input signal Vin(t), the apparatus comprising:
an input node for receiving the input signal Vin(t);
a comparator having a first input, a second input, and an output for providing a two state output signal Vout(t) wherein state changes in the output signal Vout(t) correspond to the relatively rising amplitude of the input signal Vin(t) and the relatively falling amplitude of the input signal Vin(t);
a variable shift circuit configured to provide a shifted signal Vin(t+Δt) to the second input of the comparator; and
a variable hysteresis circuit configured to provide variable hysteretic deadband appended input signal Vin+ΔV to the first input of the comparator wherein the hysteretic deadband ΔV is proportional to a resistor ratio of a first value of a programmably selected first resistor connected between the input node and the first input to the comparator and a second value of a programmably selected second resistor connected between the first input to the comparator and the output of the comparator.

21. The apparatus cited in claim 20 wherein the variable shift circuit is a constant amplitude, variable phase shifter circuit.

22. The apparatus cited in claim 20 wherein the programmably selected first resistor and the programmably selected second resistor each are a digital to analog converter.

23. The apparatus cited in claim 23 wherein the digital to analog converter\is controlled by a central processing unit.
